(19) United States
(12) Patent Application Publication
(10) Pub. No.: US 2011/0281227 A1
(43) Pub. Date: Nov. 17, 2011

(54) MELTING CRUCIBLE FOR USE IN A CRUCIBLE DRAWING METHOD FOR QUARTZ GLASS

(75) Inventors: Bernhard Franz, Giessen (DE); Nigel Whippey, Seligenstadt (DE); Joerg Becker, Niddatal (DE); Helmut Leber, Hanau (DE)

(73) Assignee: Heraeus Quarzglas GmbH & Co. KG, Hanau (DE)

(21) Appl. No.: 12/998,904

(22) PCT Filed: Dec. 9, 2009
(86) PCT No.: PCT/EP2009/066705

§ 371 Date: Jul. 26, 2011

(30) Foreign Application Priority Data
Dec. 15, 2008 (DE) 10 2008 061 871.3

(51) Int. Cl. F27B 14/10

(52) U.S. Cl. 432/264

(57) ABSTRACT

In a known melting crucible for use in a crucible drawing method, it is provided that the interior face of the crucible wall facing a crucible interior space is covered at least partially with a protective layer made of a noble metal. The known melting crucible does have good corrosion resistance with respect to the quartz glass melt, but the material costs are high because of the expensive coating metals. In order to provide a melting crucible for use in a crucible drawing method for quartz glass that exhibits good corrosion resistance at low material costs, it is proposed that the protective layer (2) be composed of a gas-tight, oxidic material that is not subject to a phase transition in the temperature range of 20° C. to 1800° C., and that the crucible interior space (17) have a gas space (17) above the quartz glass mass (27) to be held, and that the protective layer (2) be provided exclusively on the surface of the melting crucible interior face adjacent to the gas space (17).

The present invention relates to a melting crucible for use in a crucible drawing method, the melting crucible comprising a crucible interior for receiving a softened quartz glass mass, which is defined by a wall consisting of tungsten, molybdenum, niobium or tantalum or a high temperature-resistant alloy of said metals, said wall having an inside facing the crucible interior, which is covered at least in part with a protective layer.

### PRIOR ART

Melting crucibles of such types are used in a crucible drawing method for producing cylindrical components of quartz glass with any desired cross-sectional profile. Such a melting crucible is known from EP 1 160 208 A2. Granular SiO₂ start material is continuously supplied from above to the melting crucible and softened at a high temperature (>2050° C.) under a protective gas (hydrogen) exhibiting a reducing action, so that a viscous quartz glass mass is formed that is drawn off downwards in the form of a quartz glass tube in the lower portion of the melting crucible via a drawing nozzle provided in the bottom portion of the crucible. A charging hopper is provided for the supply of the particulate raw material, the charging hopper projecting into the melting crucible and having a lower end terminating above the surface of the viscous glass mass (hereinafter called “melt surface”).

The crucible materials used are normally tungsten (W), molybdenum (Mo) or alloys thereof. These refractory metals, however, are not fully resistant to corrosion and at an elevated temperature they tend to react with oxygen or other gaseous reactants, such as chlorine compounds, which may be entrained from cleaning processes of the granular SiO₂ raw material into the crucible chamber or are released as decomposition products from the raw material. Volatile metal compounds that escape from the crucible wall and are again reduced into particulate metal in the reducing crucible atmosphere are formed by reaction with the metal of the crucible wall. The metal passes into the quartz glass melt, or it is predominantly enriched on the crucible wall and in the bottom area of the melting crucible from where it its withdrawn discontinuously with the melt flow of the glass melt in concentrated form and is then noticed in the form of undissolved metal oxide particles in the quartz glass melt as striae or discolorations of the quartz glass strand and may lead to waste.

Although melting crucibles of high-melting metals selected from the group consisting of iridium, rhenium, osmium and ruthenium exhibit a much higher resistance to corrosion in comparison with the quartz glass melt, they are very expensive. As an alternative, it has been suggested that only the inside of a melting crucible, otherwise made from tungsten or molybdenum, should be protected by way of a protective layer of precious metal against corrosive attack. Melting crucibles of that type are e.g. known from the already above-indicated EP 1 160 208 A2 and from EP 1 355 861 B1 and from U.S. Pat. No. 6,739,155 B1. The inside of a tungsten crucible is here provided with a protective layer of iridium, rhenium, osmium or alloys of said metals. The protective layer is either metallurgically connected to the crucible wall or forms a separate insert part that is positioned on the crucible wall and is mechanically fixed thereto. Typical thicknesses of such protective layers are within the range of 0.5 mm to 1.27 mm.

U.S. Pat. No. 4,806,385 A discloses a protective layer for a component of molybdenum that withstands high temperatures under corrosive conditions. The molybdenum component is e.g. constituted by electrodes for use in glass melts. The protective layer is produced layer by layer by plasma spraying a powder mixture of molybdenum and Al₂O₃, the Al₂O₃ fraction increasing from the inside to the outside.

### TECHNICAL OBJECT

The last-described melting crucible exhibits improved resistance to corrosion in comparison with quartz glass melts. The material costs for producing the crucibles are, however, very high due to the expensive coating metals for forming the protective layer.

Starting from the prior art, it is the object of the present invention to provide a melting crucible for use in a crucible drawing method for quartz glass that exhibits good corrosion resistance at low material costs.

Starting from a melting crucible of the aforementioned type, this object is achieved according to the invention in that the protective layer consists of a gas-tight oxidic material which in the temperature range of 20° C. to 1800° C. is not subject to phase conversion, and that the crucible interior above the quartz glass mass to be received comprises a gas containing space, and that the protective layer is exclusively provided on the surface of the melting crucible inside that adjoins the gas containing space.

The crucible wall consists essentially of a high temperature-resistant metal, and niobium, molybdenum and tantalum are also suited, apart from tungsten. At least the inner wall of the crucible that is in contact with the hot gas atmosphere is provided completely or in part with a protective layer that is as tight as possible and consists of an oxidic material.

The protective layer reduces the action of corrosive gases, particularly of oxygen and chlorine-containing components, on the inner wall of the crucible and thereby reduces the entry of crucible metal into the quartz glass mass. In comparison with the known melting crucibles with a precious metal lining, the material used for production is however of an oxidic type and thus particularly inexpensive.

It is important that the protective layer should not peel or chip off during the heating-up period or during use of the melting crucible at least in the gas space above the quartz glass mass. The maximum temperature during the intended use of the melting crucible is typically in the range of 2000° C. and 2300° C., the gas containing space above the softened quartz glass mass having considerably lower temperatures around 500° C. The metallic crucible wall, however, can also heat up in the area of the gas containing space due to heat conduction, so that only those oxides are suited for forming the protective layer that up to a temperature of about 1800° C. are not subject to any phase conversion and do thus also not fuse below this temperature.

The interior of the crucible comprises a gas containing space above the quartz glass mass to be received, the protective layer being exclusively provided on the surface of the crucible inside adjoining the gas containing space.

As a rule, the probable melt bath level of the softened quartz glass mass is approximately known already prior to the intended use of the melting crucible. For reasons of process stability the melt bath level is preferably kept approximately constant also during use.

The softened quartz glass mass can dissolve the oxidic protective layer. A protective layer ending below the melt level will therefore be removed over time. In this process the elements contained in the protective layer as well as possible impurities pass into the quartz glass mass. This is normally acceptable as long as the dissolution of the protective layer takes place during the running-in of the drawing furnace and a long running-in period is acceptable, i.e. in the case of large batches. The advantage of this procedure is that the undissolved protective layer that remains after such a process ends quite exactly at the melt level. It is therefore harmless or even preferred when the protective layer is configured right from the start in such a way that it projects into the quartz glass mass.

In the embodiment of the melting crucible according to the invention it is however intended that the protective layer is only provided in the gas containing space right from the beginning, i.e. before the intended use of the melting crucible, and does thus not get into contact with the quartz glass melt.

The protective layer ends exactly at the predetermined melt bath level or slightly thereabove—in the first-mentioned case, variations of the melt level can effect dissolution of the protective layer over a certain, though small, height, and in the last-mentioned case a small surface area with an unprotected crucible wall has to be accepted. The smaller this surface area can be kept, the smaller is the corrosive attack by the gas atmosphere. An unprotected surface area with a height of about 2 cm is acceptable as a rule.

A further advantage of the melting crucible of the invention must be seen in the fact that only a relatively small surface area has to be coated, namely the surface area of the inside of the melting crucible that gets into contact with the corrosive atmosphere in the gas containing space. Therefore, it is preferably intended that the surface provided with the protective layer makes up less than 30%, preferably less than 25%, of the total inside surface.

It has turned out to be advantageous when the protective layer contains an oxide selected from the following group: aluminum, magnesium, yttrium, zirconium, and rare-earth metals.

The oxides or mixed oxides of said metals exhibit good adhesion to crucible surfaces, particularly of tungsten. In this context the term “rare earths” encompasses lanthanides (including lanthanum) as well as Sc and Y. In the case of zirconium oxide, preference is given to stabilized ZrO₂ which contains a certain amount of Y₂O₃.

A protective layer made of Al₂O₃ has turned out to be particularly useful.

Al₂O₃ forms part of naturally occurring raw materials of quartz glass and is harmless for most applications of quartz glass. This is equally true for ZrO₂ which is acceptable and specified as a dopant up to a content of 0.7 wt. ppm for many quartz-glass applications.

Doping with Al₂O₃ effects an increase in the viscosity of quartz glass; this may even be desired. Therefore, a certain enrichment of the quartz glass mass with the Al₂O₃ entrained from the protective layer is harmless as a rule. The thermal expansion coefficient of aluminum oxide is in the range of 5.5 to 7×10⁻⁶ K⁻¹ and thus in the order of the thermal expansion coefficients of tungsten (4.3 to 4.7×10⁻⁶ K⁻¹) and molybdenum (5.3×10⁻⁶ K⁻¹). The similar thermal expansion coefficients are conducive to a good adhesion of the layer to the crucible wall.

In this context it has turned out to be advantageous when the protective layer has a mean layer thickness in the range of 50 μm to 500 μm, particularly preferably in the range of 100 μm and 200 μm.

The protective layer acts as a diffusion barrier to the ingress of corrosive gases to the wall of the crucible base body. The function as a diffusion barrier layer is the more pronounced the thicker the protective layer is. On the other hand, with an increasing thickness of the protective layer the risk of chipping due to differences in the thermal expansion coefficients of layer and crucible wall is also increasing. In this respect, layer thicknesses in the range of 50 μm to 500 μm, particularly those in the range of 100 μm to 200 μm, have turned out to constitute an appropriate compromise.

The protective layer is preferably produced by thermal spraying.

During thermal spraying oxidic or slightly oxidizable metallic start powder particles in the form of a fluid mass, such as a free-flowing powder, sol or suspension (dispersion), are supplied to an energy carrier, they are fused therein at least in part and flung at a high speed onto the crucible surface to be coated. The energy carrier is normally an oxy-fuel gas flame or a plasma jet, but it may also be configured as an electric arc, laser beam, or the like.

A protective layer produced by plasma spraying is particularly preferred.

The high-energy plasma spraying method permits a comparatively high energy input and a high speed while the fused or partially molten start powder particles are flung onto the surface to be coated. Relatively thick and firmly adhering protective layers can thereby be produced within a short period of time. In the presence of oxygen in the plasma flame it is furthermore possible to use metallic start powder particles that are oxidized in the plasma flame or during deposition on the surface. Particularly fine particles can here be used, which facilitates the formation of thin protective layers.

### EMBODIMENT

The invention will now be described in more detail with reference to embodiments and a drawing, in which drawing:

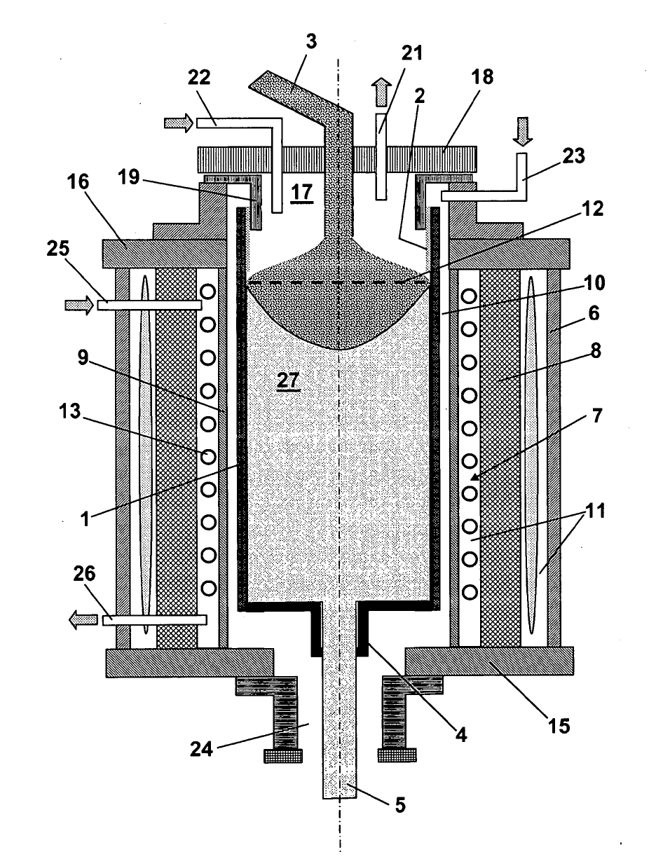

FIG. 1 shows an embodiment of the melting crucible according to the invention in a drawing furnace for making quartz glass tubes.

### PRELIMINARY TEST

In a preliminary test, tungsten plates were each provided with an oxidic protective layer by way of vacuum plasma spraying (VPS). The coating parameters were varied here. Different oxidic powders with a grain ranging from 10 μm to 100 μm were used as the start substance for the protective layers.

The W plates thereby provided with different protective layers were then heated up to a temperature of 1800° C. and kept at this temperature in an atmosphere of hydrogen with 1 vol. % HCl for 40 days. The plates were then cooled and the state of the protective layers and the quality of the boundary surface between plate body and the respective layer material was then assessed on the basis of micrographs. The chemical composition, the mean layer thickness and other qualitatively assessed properties of the oxidic protective layers can be seen in Table 1.

TABLE 1

| | Protective layer | | |
|---|---|---|---|
| | | Thickness | |
| Test | Composition | [μm] | Result |
| 1 | 100% Al₂O₃ | 150 | High adhesion; layer is tight; low |
| | | | corrosion |
| 2 | 50% Al₂O₃ | 100 | Acceptable adhesion; corrosion |
| | 50% MgO | | to a minor degree |
| 3 | 100% Y₂O₃ | 150 | High adhesion; layer is tight; no |
| | | | significant corrosion |
| 4 | 100% stabilized | 200 | High adhesion; layer is tight; |
| | ZrO₂ | | holes on the phase boundary |

### Use of the Melting Crucible According to the Invention in a Drawing Furnace

On the inner wall of a crucible base body of tungsten, the melt bath height of the soften quartz glass mass to be expected in the intended use of the melting crucible was marked by way of a surrounding line. The surface area above said line was coated by vacuum plasma spraying (VPS) with a protective layer of pure Al₂O₃ having a thickness of 150 μm on average. The crucible coated in this way was used in a drawing furnace, as will be described in more detail hereinafter with reference to FIG. 1.

The drawing furnace comprises the melting crucible 1 of tungsten into which SiO₂ granules 3 are continuously filled from above via a supply nozzle. A drawing nozzle 4 through which the softened quartz glass mass 27 exits and is drawn off as a strand 5 is used in the bottom area of the melting crucible 1.

The melting crucible 1 is surrounded by a water-cooled furnace jacket 6 while maintaining an annular gap 7 that is divided by a separation wall 9 of molybdenum, which is sealed in the area of its two faces relative to a bottom plate 15 and a top plate 16 of the furnace jacket 6, into an interior ring chamber 10 and an exterior ring chamber 11.

Inside the exterior ring chamber 11, a porous insulation layer 8 of oxidic insulation material is accommodated, and inside the exterior ring chamber 11 a resistance heater 13 is provided for heating the melting crucible 1.

The melting crucible 1 encloses a gas containing space 17 above the softened quartz glass mass 27, which is also sealed relative to the environment by means of a cover 1 and a sealing element 19. The cover 18 is provided with an inlet 21 and an outlet 22 for a crucible interior gas in the form of pure hydrogen.

Likewise, the interior ring chamber 10 is provided in the upper area with a gas inlet 23 for pure hydrogen. The interior ring chamber 10 is downwardly open, so that hydrogen can escape via the bottom opening 24 of the furnace jacket 6.

In the area of the upper end the exterior ring chamber 11 comprises an inlet 25 for a protective gas in the form of a nitrogen/hydrogen mixture (5 vol. % H₂) and, in its lower area, an outlet 26 for the protective gas. The protective gas flows through the porous insulation layer 8 and around the outer wall of the separation wall 9.

The gas containing space 17 ends at the “melt level” of the quartz glass mass 27, which is outlined by the broken line 12. The surface area of the inner wall of the melting crucible adjoining the gas containing space 17, which makes up about 20% of the total inner surface of the melting crucible 1, is almost completely provided with the protective layer 2 of Al₂O₃. The protective layer 2 extends from a height of just above (about 2 cm) the melt level 12 up to and under the sealing element 19. Hence, the atmosphere inside the gas containing space 17 has no access to or has at best some minor access to free tungsten surface.

1. A melting crucible for use in a crucible drawing method, said crucible comprising:
a wall defining a crucible interior configured to receive a softened quartz glass mass extending up to a level in the crucible said wall being of a metal selected from the group of metals consisting of tungsten, molybdenum, niobium, and tantalum or a high temperature-resistant alloy of said metals;
said wall having an inward surface facing the crucible interior that is covered at least in part with a protective layer; and
wherein the protective layer consists of a gas-tight oxidic material that is not subject to phase conversion in a temperature range of 20° C. to 1800° C., and the crucible interior above the level of the quartz glass mass is a gas containing space, and the protective layer is exclusively on the inward surface facing the gas containing space.

2. The melting crucible according to claim 1, wherein the surface provided with the protective layer makes up less than 30% of a total inside surface of the crucible.

3. The melting crucible according to claim 1, wherein the protective layer contains an oxide selected from the group consisting of aluminum, magnesium, yttrium, zirconium, and rare-earth metals.

4. The melting crucible according to claim 1, wherein the protective layer is made of Al₂O₃.

5. The melting crucible according to claim 1, wherein the protective layer has a mean layer thickness in a range of 50 μm to 500 μm.

6. The melting crucible according to claim 1, wherein the protective layer is produced by thermal spraying.

7. The melting crucible according to claim 1, wherein the surface provided with the protective layer makes up less than 25% of a total inside surface of the crucible.

8. The melting crucible according to claim 1, wherein the protective layer has a mean layer thickness in a range of 100 μm to 200 μm.

9. The melting crucible according to claim 1, wherein the protective layer is produced by plasma spraying.
